(19) United States
(12) Patent Application Publication
(10) Pub. No.: US 2024/0261616 A1
(43) Pub. Date: Aug. 8, 2024

(54) SYSTEMS AND METHODS OF TORQUE LIMITING SPRINKLER INSTALLATION TOOLS

(71) Applicant: Tyco Fire Products LP, Cranston, RI (US)

(72) Inventors: William K. Rucker, Cranston, RI (US); Steven L. Shields, Lubbock, TX (US); Daniel Cross, South Kingston, RI (US)

(73) Assignee: Tyco Fire Products LP, Cranston, RI (US)

(21) Appl. No.: 18/565,199

(22) PCT Filed: Jul. 27, 2022
(86) PCT No.: PCT/IB2022/056908

§ 371 Date: Nov. 29, 2023

Related U.S. Application Data
(60) Provisional application No. 63/228,350, filed on Aug. 2, 2021.

(51) Int. Cl. A62C 99/00; A62C 35/68

(52) U.S. Cl. CPC A62C 99/009; A62C 35/68

(57) ABSTRACT

A sprinkler installation tool includes a first member, a second member, and at least one bearing. The first member defines an axis and include a first surface transverse to the axis. The first surface includes at least one first opening. The second member includes a second member including a second surface in contact with the first surface. The second surface includes at least one second opening. The at least one bearing is between the at least one first opening and the at least one second opening to engage the at least one first opening and the at least one second opening such that a torque applied to the first member to cause the first member to rotate about the axis relative to the second member causes the second member to rotate with the first member responsive to the torque being less than a target torque of rotation of a sprinkler.

### CROSS-REFERENCE TO RELATED APPLICATIONS

The present application claims the benefit of and priority to U.S. Provisional Application No. 63/228,350, filed Aug. 2, 2021, the disclosure of which is incorporated herein by reference in its entirety.

### BACKGROUND

Sprinkler systems can be provided in buildings to address fire conditions. Sprinkler systems can include fire protection sprinklers that connect with piping systems to receive fluid to address the fire conditions. Sprinklers can be installed to connect the sprinklers with piping components. For example, a sprinkler can be engaged with a pipe, pipe adapter, or other component, and rotated using a wrench or other tool to form a connection between the sprinkler and the component.

### SUMMARY

At least one aspect relates to a sprinkler installation tool. The sprinkler installation tool can include a first member, a second member, and at least one bearing. The first member can define an axis and include a first surface transverse to the axis. The first surface can include at least one first opening. The second member can include a second member including a second surface in contact with the first surface. The second surface can include at least one second opening. The at least one bearing can be between the at least one first opening and the at least one second opening to engage the at least one first opening and the at least one second opening such that a torque applied to the first member to cause the first member to rotate about the axis relative to the second member causes the second member to rotate with the first member responsive to the torque being less than a target torque of rotation of a sprinkler.

At least one aspect relates to a sprinkler installation kit. The kit can include a tool, a drive, and a wrench. The tool can include a first member defining an axis and including a first surface transverse to the axis and including at least one first opening, a second member including a second surface in contact with the first surface and including at least one second opening, at least one bearing between the at least one first opening and the at least one second opening. The drive can be to rotate the first member. The wrench can be to couple with the tool and with a sprinkler.

At least one aspect relates to a tool. The tool can include a first member defining an axis and including a first surface transverse to the axis. The first surface can include at least one first opening. The tool can include a second member including a second surface in contact with the first surface. The second surface can include at least one second opening. The tool can include at least one bearing between the at least one first opening and the at least one second opening. The tool can include a body around the first member and the second member.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts an example of installation of a sprinkler.

FIG. 2 depicts an example of a sprinkler installation tool.

FIG. 3 depicts an example of a member of a sprinkler installation tool.

### DETAILED DESCRIPTION

The present disclosure relates generally to fire sprinkler installation devices. More particularly, the present disclosure relates to a torque limiting sprinkler installation tool.

Sprinklers can be installed in a building or other space by connecting the sprinkler with one or more components connected with a fluid source, such as one or more piping components. Installing the sprinkler can require applying torque to the sprinkler (e.g., using a sprinkler wrench) to enable a seal to be formed between the sprinkler and the one or more piping components.

Applying too much torque to the sprinkler can damage the sprinkler, which can result in immediate or latent leakage, while applying too little torque can prevent adequate sealing from being achieved, which can again lead to leakage.

Systems and methods in accordance with the present disclosure can use a sprinkler installation tool that enables targeted application of torque to the sprinkler, such that up to a threshold amount of torque can be applied, and torque greater than the threshold amount will result in no further rotation of the sprinkler. This can increase the speed at which the sprinkler can be installed while preventing installation from being performed in a manner that leads to leakage. In addition, the sprinkler installation tool can allow for free rotation of the sprinkler in a direction for removing the sprinkler.

For example, a sprinkler installation tool can include a first member, a second member, and at least one bearing. The first member can define an axis and include a first surface transverse to the axis. The first surface can include at least one first opening. The second member can include a second surface in contact with the first surface. The second surface can include at least one second opening. The at least one bearing can be between the at least one first opening and the at least one second opening. The at least one bearing can engage the at least one first opening and the at least one second opening such that a torque applied to the first member to cause the first member to rotate about the axis relative to the second member causes the second member to rotate with the first member responsive to the torque being less than a target torque of rotation of a sprinkler.

The sprinkler installation tool can include a body around the first member and the second member, which can receive a drive or other component to rotate the first member. A spring can be positioned adjacent to the second member on an opposite side of the second member from the first member to apply a compression force along the axis against the second member towards the first member, causing frictional engagement between the first surface, the second surface, and the at least one bearing to allow the first member, second member, and body to rotate together, which can be overcome when the torque is greater than the target torque, such that the first and second member are spaced apart (by pushing back against the spring) to allow the first member to rotate within the body without rotating the body, preventing excessive torque from being transferred to the sprinkler.

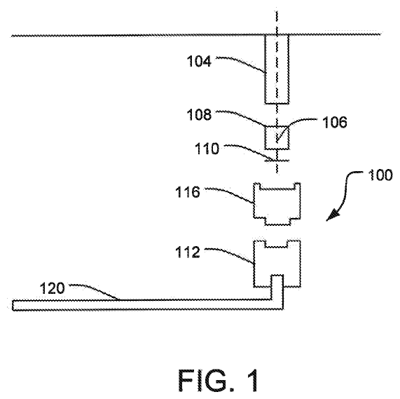

FIG. 1 depicts an example of a sprinkler installation device 100 to install a sprinkler 108 with a pipe 104. The pipe 104 can be coupled with a fluid source (not depicted), which can provide fluid from a remote or local location to a building in which the pipe 104 is located. The fluid supply may include, for example, a municipal water supply, pump, piping system, tank, cylinder, or any other source of water or fire suppression agent.

The pipe 104 (e.g., one or more pipes, tubes, conduits, or fittings) can include or be coupled with a pipe component such as a pipe, pipe adapter, sprinkler adapter, tee joint, elbow joint, or other component to which to connect the sprinkler 108 to connect the sprinkler 108 with the fluid source. The pipe 104 can include one or more pipe components.

The sprinkler 108 can be any of a variety of fluid distribution devices, such as sprinklers having a sealed passageway coupled with the pipe 104 that opens responsive to a fire condition (e.g., responsive to a thermal element positioned against a seal in the passageway breaking due to the fire condition), or open nozzles. The sprinkler 108 can be, for example, an upright sprinkler, pendent sprinkler, concealed sprinkler, sidewall sprinkler, or other fluid distribution device. The sprinkler 108 can include threading to engage threading of the pipe 104 to connect the sprinkler 108 with the pipe 104, such that torque applied to the sprinkler 108 about an axis 106 of the sprinkler 108 engages the threading.

The sprinkler 108 can include a deflector 110. The deflector 110 can receive fluid from the pipe 104 through the sprinkler 108, and output the received fluid with a target spray pattern. The target spray pattern can correspond to how the outputted fluid is used to address a fire condition, such as the volume of fluid to be outputted in particular areas or volumes of space relative to the position of the deflector 110. A rotational angle of the deflector 110 relative to the axis 106 of the sprinkler 108 can modify the target spray pattern. For example, the target spray pattern can be asymmetrical relative to the axis, such as by being rectangular or oval. As such, rotation of the sprinkler 108 to install the sprinkler with the pipe 104 can modify the target spray pattern.

The sprinkler installation device 100 can include one or more components to apply torque to the sprinkler 108 to connect the sprinkler 108 with the pipe 104. As depicted in FIG. 1, the sprinkler installation device 100 can include a sprinkler installation tool 112 that can couple with the sprinkler 108 to rotate the sprinkler 108 about the axis 106. The sprinkler installation tool 112 can be used as a torque limiting adapter to limit torque application to the sprinkler 108 to be less than or equal to a target torque for installation of the sprinkler 108, which can facilitate prevention of leakage resulting from the installation process.

The sprinkler installation tool 112 can be integrally formed with or removably coupled with one or more drive components to enable rotation of the sprinkler installation tool 112. The one or more drive components can include various wrenches, sockets, ratchets, drives, or combinations thereof. For example, as depicted in FIG. 1, a first drive 116 (e.g., sprinkler wrench, sprinkler socket) can be attached with the sprinkler installation tool 112, and a second drive 120 can be attached with the sprinkler installation tool 112 to rotate the first drive 116 to rotate the sprinkler 108 (e.g., the torque applied to the second drive 120 can be transmitted through the sprinkler installation tool 112 and the first drive 116 to cause rotation of the sprinkler 108. The sprinkler installation tool 112, first drive 116, and second drive 120 (and any other drive components) can include various male or female ends, threading, or combinations thereof to allow for connection and attachment in order to rotate the sprinkler 108.

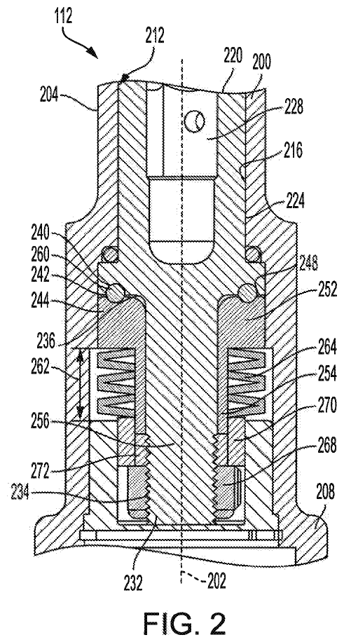

FIG. 2 depicts an example of the sprinkler installation tool 112. The sprinkler installation tool 112 can include a body 200. The body 200 can form an outer portion of the sprinkler installation tool 112. The body 200 can extend from a first end 204 to a second end 208. The first end 204 can receive drive components (e.g., first drive 116 described with reference to FIG. 1) to cause rotation of the sprinkler installation tool 112. The first end 204 can define a first opening 212 adjacent to which first member 220 can be received (e.g., to allow for access to first member 220).

The second end 208 can attach with the sprinkler 108. For example, the second end 208 can define an opening (e.g., socket) to engage the sprinkler 108, such as to be positioned around the deflector 110 and at least a portion of the sprinkler 108, such as wrench flats or other engagement members on an outer surface of the sprinkler 108.

The body 200 can define an inner wall 216 extending from the first end 204 to the second end 208. Various components of the sprinkler installation tool 112 as described herein can be received within the inner wall 216 and positioned in contact with the inner wall 216. As depicted in FIG. 1, the inner wall 216 can be stepped to increase in inner diameter at various points from the first end 204 towards the second end 208.

The sprinkler installation tool 112 can include a first member 220. The first member 220 can receive torque (e.g., from first drive 116) to be transmitted to the sprinkler 108. The first member 220 can be a spud. The first member 220 can have a first outer surface 224 shaped to contact the inner wall 216. For example, the inner wall 216 and the first outer surface 224 can be cylindrical.

The first member 220 can include a tool receiver 228. The tool receiver 228 can be shaped to receive a tool, such as the first drive 116, to be driven by the tool in order to rotate the first member 220. For example, the tool receiver 228 can have a hex shape or other shape to receive the first drive 116. The tool receiver 228 can open on a same side of the first member 220 as the first opening 212 to allow for the first drive 116 to be received into tool receiver 228 along axis 202 adjacent first end 204 opposite second end 208.

The first member 220 can define an axis 202. The axis 202 can be a longitudinal axis of the first member 220 extending through the tool receiver 228 to a distal end 232 of the first member 220. The distal end 232 can define threading 234. The body 200 and first member 220 can be coaxial about the axis 202.

The first member 220 can define a first surface 236 transverse to the axis 202. For example, the first surface 236 can be perpendicular to the axis 202. The first surface 236 can correspond to an inwardly extending portion of the first member 220 relative to a portion of the first member 220 between the first surface 236 and the tool receiver 228. The first surface 236 can be annular. The first surface 236 can extend to a greatest diameter of the first member 220.

The first surface 236 can include a first channel 240 that includes at least one first opening 242. As described further herein, the first channel 240 and the at least one first opening 242 can receive and can rotate together with or relative to one or more bearings 260 to allow the first member 220 to be freely rotated relative to other components of the sprinkler installation tool 112 in order to prevent excessive torque from being transmitted to the sprinkler 108. The first channel 240 can extend fully circumferentially around the axis 202 to allow for continuous rotation of the first member 220 responsive to the torque being greater than the target torque. At least one of the first channel 240 and the at least one first opening 242 can have an asymmetrical surface, so that the sprinkler installation tool 112 prevents excessive torque in a first direction around the axis 202 (e.g., clockwise) without preventing rotation in a second direction opposite the first direction (e.g., counter-clockwise). For example, the at least one of the first channel 240 and the at least one first opening 242 can have a surface that is asymmetrical on either side of a plane in which the axis 202 lies (e.g., the plane of FIG. 2).

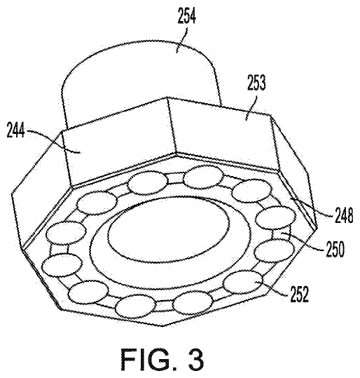

As depicted in FIG. 2 and FIG. 3, the sprinkler installation tool 112 can include a second member 244 received in the body 200 and adjacent to the first member 220. For example, the second member 244 can define a second surface 248 facing the first surface 236. As depicted in FIG. 3, the second surface 248 can include a second channel 250 that includes at least one second opening 252, which can cooperate with the first channel 240 and at least one first opening 242 to receive the bearings 260 and allow for engagement with or movement of the bearings 260 relative to the members 220, 244. The first channel 240 and at least one first opening 242 can be shaped similarly or identically to the respective second channel 250 and at least one second opening 252.

The second member 244 can include a first portion 253 and a second portion 254 having a lesser outer diameter than the first portion 253. An extension 256 of the first member 220 can be received through the first portion 253 and the second portion 254.

The sprinkler installation tool 112 can include at least one spring 264. The spring 264 can be a plurality of springs (e.g., a Belleville spring stack). The spring 264 can be positioned to face the first portion 253 of the second member 244 and around the second portion 254 of the second member 244. The spring 264 can be aligned with the second member 244 so that a spring force of the spring 264 (e.g., based on how much the spring 264 is compressed, which can correspond to a length 262 in a compressed state and a spring constant of the spring 264) is applied along the axis 202 against the second member 244.

The spring 264 can be on an opposite side of the second member 244 from the bearing 260 to apply the spring force on the second member 244 towards the first member 220 to frictionally engage the bearing 260 with the first surface 236 and the second surface 248, such as by compressing the second member 244 against the bearing 260 and the first member 220; the first member 220 can be fixed along the axis 202 relative to the body 200 due to one or more walls of at least one of the first member 220 and the body 200 that are not parallel with the axis 202.

The spring installation tool 112 can include at least one locking member 268. The locking member 268 can include threading to couple with the threading 234 of the first member 220, so that a position of the locking member 268 along the axis 202 is fixed relative to the first member 220.

A support 270 (which can be separate from the locking member 268 or integrally formed with the locking member 268) can be positioned between the locking member 268 and the spring 264, so that the position to which the locking member 268 is threaded along the extension 256 corresponds to the length 262 of the spring 264 in the compressed state (e.g., as the locking member 268 is threaded closer to the spring 264, the spring 264 will be further compressed, increasing the spring force, or vice versa). The support 270 can define a receiver 272 spaced from the extension 256 to allow for translation of the support 270 relative to the second portion 254 of the second member 244.

In various examples of operation of the sprinkler installation tool 112, the sprinkler installation tool 112 can transfer torque to the sprinkler 108 during rotation of the first member 220 responsive to the torque being less than or equal to a threshold torque, and not transfer the torque to the sprinkler 108 responsive to the torque being greater than the threshold torque. The threshold torque can be a target torque for rotation of the sprinkler 108 to prevent overtightening of the sprinkler 108. The threshold torque can be set based on the spring force of the spring 264 as applied along the axis 202 to the second member 244. The spring force can frictionally engage the second member 244 with the bearings 260 (and the first member 220), such that a friction force in a direction transverse to the axis 202 results from the spring force (as well as the geometry of the bearings 260, the channels 240, 250, and the openings 242, 252). Greater values of the spring force (resulting from lesser values of the length 262) can result in greater values of the friction force (and vice versa).

The friction force can correspond to the threshold torque. Responsive to torque applied to the first member 220 to rotate the first member 220 about the axis 202 being less than or equal to the threshold torque, the first member 220 and second member 244 are maintained in an engagement state (e.g., as depicted in FIG. 2) due to the frictional engagement between the bearings 260 and the openings 242, 252 in which the bearings 260 are positioned. Responsive to the torque applied to the first member 220 being greater than the threshold torque, the bearings 260 disengage from at least one of the first openings 242 and the second openings 252 and move into at least one of the channel 240 and the channel 250, separating the first member 220 from the second member 244 (by overcoming the spring force of the spring 264 to push the second member 244 and spring 264 away from the first member 220 along the axis 202) so that the first member 220 does not cause rotation of the second member 244, and thus does not cause rotation of the sprinkler 108 coupled with the second member 244. While the bearings 260 are outside of the openings 242, 252 in the channels 240, 250, the first member 220 will rotate relative to the second member 244 until the bearings 260 are again received in respective openings 242, 252 of both the first and second members 220, 244, re-engaging the first member 220 with the second member 244.

As noted above, at least one of the openings 242, 252 can have an asymmetrical shape, which can allow for the torque limiting operations described herein to separate the first and second members 220, 244 to occur for a first direction of rotation about the axis 202 (e.g., clockwise rotation) while retaining the engagement between the bearings 260 and the member 220, 244 in a second direction of rotation opposite the first direction (e.g., counter-clockwise rotation). This can facilitate removal of the sprinkler 108, which may require greater torque than the target torque of rotation due to factors such as buildup of material around the sprinkler 108.

As utilized herein, the terms “approximately,” “about,” “substantially”, and similar terms are intended to include any given ranges or numbers+/−10%. These terms include insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The construction and arrangement of the fitting assembly as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A sprinkler installation tool, comprising:
a first member defining an axis and comprising a first surface transverse to the axis, the first surface comprising at least one first opening;
a second member comprising a second surface in contact with the first surface, the second surface comprising at least one second opening; and
at least one bearing between the at least one first opening and the at least one second opening, the at least one bearing to engage the at least one first opening and the at least one second opening such that a torque applied to the first member to cause the first member to rotate about the axis relative to the second member causes the second member to rotate with the first member responsive to the torque being less than a target torque of rotation of a sprinkler.

2. The sprinkler installation tool of claim 1, comprising:
a body around the first member and the second member, the body extending from a first end defining a first body opening adjacent to the first member to a second end to engage at least one of the sprinkler and a wrench.

3. The sprinkler installation tool of claim 1, comprising:
a spring on an opposite side of the second member from the at least one bearing to apply a spring force on the second member towards the first member to frictionally engage the at least one bearing with the first surface and the second surface.

4. The sprinkler installation tool of claim 1, comprising:
a spring on an opposite side of the second member from the at least one bearing to apply a spring force on the second member towards the first member to frictionally engage the at least one bearing with the first surface and the second surface; and
a locking member coupled with the second member to compress the spring against the second member.

5. The sprinkler installation tool of claim 1, comprising:
the first surface comprises a channel extending circumferentially around the first surface, the at least one first opening defined into the first member from the channel.

6. The sprinkler installation tool of claim 1, comprising:
at least one of the at least one bearing and the at least one first opening defines an asymmetric surface.

7. The sprinkler installation tool of claim 1, comprising:
the first member defines a tool receiver to receive a tool to rotate the first member about the axis.

8. The sprinkler installation tool of claim 1, comprising:
the at least one first opening and the at least one second opening each define an angled surface such that rotation of the first member around the axis causes a force along the axis to be transmitted from the first member to the second member.

9. A sprinkler installation kit, comprising:
a tool, comprising:
a first member defining an axis and comprising a first surface transverse to the axis, the first surface comprising at least one first opening;
a second member comprising a second surface in contact with the first surface, the second surface comprising at least one second opening; and
at least one bearing between the at least one first opening and the at least one second opening;
a drive to rotate the first member; and
a wrench to couple with the tool and with a sprinkler.

10. The sprinkler installation kit of claim 9, comprising:
a body around the first member and the second member, the body extending from a first end defining a first body opening adjacent to the first member to a second end, the first body opening to receive the drive, the second end to couple with the wrench.

11. The sprinkler installation kit of claim 9, comprising:
a spring on an opposite side of the second member from the at least one bearing to apply a spring force on the second member towards the first member to frictionally engage the at least one bearing with the first surface and the second surface.

12. The sprinkler installation kit of claim 9, comprising:
a spring on an opposite side of the second member from the at least one bearing to apply a spring force on the second member towards the first member to frictionally engage the at least one bearing with the first surface and the second surface; and
a locking member coupled with the second member to compress the spring against the second member.

13. The sprinkler installation kit of claim 9, comprising:
the first surface comprises a channel extending circumferentially around the first surface, the at least one first opening defined into the first member from the channel.

14. The sprinkler installation kit of claim 9, comprising:
at least one of the at least one bearing and the at least one first opening defines an asymmetric surface.

15. The sprinkler installation kit of claim 9, comprising:
the first member defines a tool receiver to receive the drive.

16. The sprinkler installation kit of claim 9, comprising:
the at least one first opening and the at least one second opening each define an angled surface such that rotation of the first member around the axis causes a force along the axis to be transmitted from the first member to the second member.

17. A tool, comprising:
a first member defining an axis and comprising a first surface transverse to the axis, the first surface comprising at least one first opening;
a second member comprising a second surface in contact with the first surface, the second surface comprising at least one second opening;
at least one bearing between the at least one first opening and the at least one second opening; and
a body around the first member and the second member.

18. The tool of claim 17, comprising:
a spring on an opposite side of the second member from the at least one bearing to apply a spring force on the second member towards the first member to frictionally engage the at least one bearing with the first surface and the second surface;
a locking member coupled with the second member to compress the spring against the second member.

19. The tool of claim 17, comprising:
the first surface comprises a channel extending circumferentially around the first surface, the at least one first opening defined into the first member from the channel, at least one of the at least one bearing and the at least one first opening defines an asymmetric surface.

20. The tool of claim 17, comprising:
the at least one first opening and the at least one second opening each define an angled surface such that rotation of the first member around the axis causes a force along the axis to be transmitted from the first member to the second member.
